(19) United States
(12) Patent Application Publication
(10) Pub. No.: US 2012/0030005 A1
(43) Pub. Date: Feb. 2, 2012

(54) METHOD AND SYSTEM FOR PROVIDING ADVERTISEMENTS

(75) Inventor: Arpit GUPTA, Delhi (IN)

(73) Assignee: Yahoo! Inc, Sunnyvale, CA (US)

(21) Appl. No.: 12/844,847

(22) Filed: Jul. 28, 2010

(51) Int. Cl. G06Q 30/00

(52) U.S. Cl. 705/14.41; 705/14.49

(57) ABSTRACT

An example of a method includes electronically blending an advertisement into a web page based on physical attributes of the web page and providing the web page with the advertisement.

### BACKGROUND

Over a period of time, advertising using websites has become a common activity. Website owner generates revenue by displaying advertisements on their website. Website owner also generates revenue based on number of advertisements being clicked or accessed by users. Hence, it is desired to increase number of clicks by using better ways of advertising.

### SUMMARY

An example of a method includes electronically blending an advertisement into a web page based on physical attributes of the web page and providing the web page with the advertisement.

An example of a system includes a server. The server includes a communication interface, a memory to store instructions and a processor coupled to the memory and the communication interface which is responsive to the instructions to blend an advertisement into a web page based on physical attributes of the web page and to provide the web page with the advertisement.

An example of an article of manufacture includes a machine-readable medium, and instructions carried by the machine-readable medium and operable to cause a programmable processor to perform blending of an advertisement into a web page based on physical attributes of the web page and providing the web page with the advertisement.

Another example of method includes step of determining physical attributes associated with an interface of an application and electronically modifying an advertisement based on the physical attributes associated with the interface of the application. The method further includes electronically positioning the advertisement on the interface of the application and enabling display of the interface with the advertisement.

### BRIEF DESCRIPTION OF THE FIGURES

FIG. 1 depicts a block diagram of an environment, in accordance with one embodiment;

FIG. 2 illustrates a method for providing advertisements by a server, in accordance with one embodiment;

FIG. 3 illustrates a method for providing advertisements by a server, in accordance with another embodiment;

FIG. 4 illustrates a web page with an advertisement, in accordance with one embodiment;

FIG. 5 illustrates a method for providing advertisements by an electronic device, in accordance with one embodiment;

FIG. 6 depicts a block diagram of a server, in accordance with one embodiment.

### DETAILED DESCRIPTION OF THE EMBODIMENTS

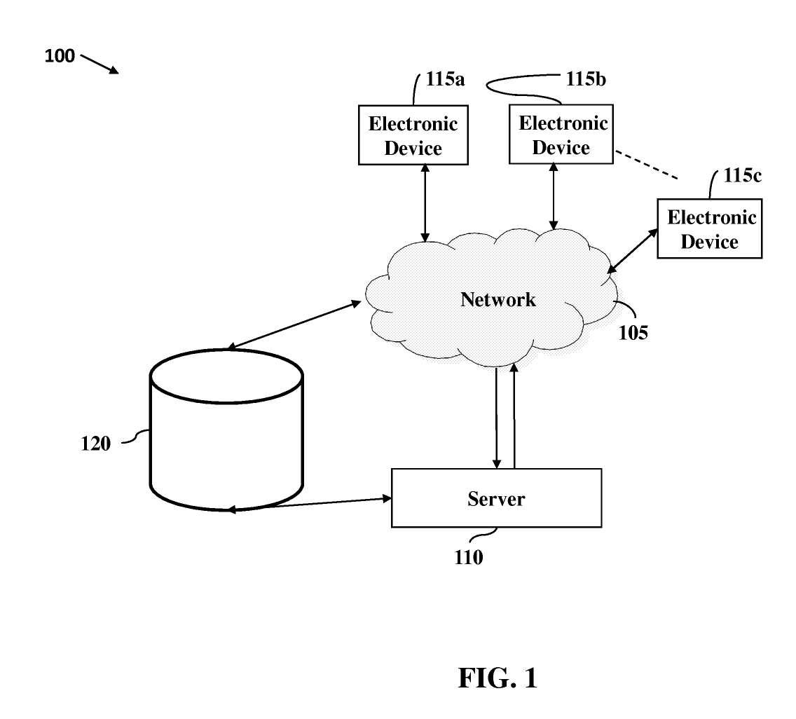

FIG. 1 depicts a block diagram of an environment 100. The environment 100 includes a server 110 connected to a network 105. The environment 100 further includes one or more electronic devices, for example an electronic device 115a, an electronic device 115b and an electronic device 115c which can communicate with each other through the network 105. Examples of the electronic devices include, but are not limited to, computers, mobile devices, laptops, palmtops, and personal digital assistants (PDAs). The electronic devices can also communicate with the server 110 through the network 105.

The server 110, for example a Yahoo!® server can be coupled to a storage device 120.

The environment 100 can also include an advertisement server that can be in electronic communication with the server 110 through the network 105.

An example of interaction among various entities in the environment 100 is now provided using the electronic device 115a.

A user of the electronic device 115a wishes to open a web page. The user types a uniform resource locator (URL), for example www.yahoo.com, for the webpage in a browser.

A plug-in installed in the electronic device 115a detects physical attributes of the web page. The URL along with the physical attributes of the web page is electronically sent to the server 110.

The server 110 receives the URL and the physical attributes of the web page. Examples of the physical attributes include color of the web page, size of the web page, texture of the web page, contrast of the web page, theme of the web page and layout of the web page.

In some embodiments, the electronic device 115a may not have the plug-in installed and in such cases the server 110 receives the URL, and determines the physical attributes of the web page. The physical attributes are determined from code of the web page. Examples of a format of the code include hyper text markup language (HTML) format and extensible markup language (XML) format. The code can be parsed and processed to extract the physical attributes.

The server 110 identifies or receives one or more advertisements that need to be displayed on the web page. The advertisement can be accessed from a storage device 120. The server 110 then blends the advertisements into the web page. Blending includes at least one of modifying the advertisements and positioning the advertisements onto the web page. The modifying and the positioning are based on the physical attributes. Modifying an advertisement includes at least one of changing color of the advertisement, changing size of the advertisement, changing texture of the advertisement and changing contrast of the advertisement.

The server 110 or the plug-in also determines a position on the web page for displaying the advertisements. Different positions can be determined for different advertisements. The web page is divided into various frames. A frame can be defined as a block of content having similar physical attributes. Each frame can be in HTML or XML format. The frames can be accessed from the code. Locations of the frames on the web page can also be determined. If gap between end of a first frame and start of a second frame exceeds a predefined threshold then the gap can be determined as the position for displaying an advertisement. The advertisement can then be resized to fit into the position.

The server 110 then sends the web page with the advertisements blended into the web page to the electronic device 115a via the network 105.

The electronic device 115a receives the web page with the advertisements and displays the web page with the advertisements.

Blending an advertisement into the web page makes the advertisement look like part of content of the web page. This increases probability of the advertisement being accessed or clicked. Moreover, user experience is also enhanced as the user does not see the advertisement separately but as a part of the web page.

It is noted that the disclosure is explained with help of the web page as an example. The blending of the advertisement can be performed for various applications where advertising is performed. For example, blending the advertisement into interfaces of various applications including Yahoo! Messenger.

Examples of the advertisements include images, video files, flash files, animation, text, and smart advertisements.

A smart advertisement is an advertisement that can be customized based on various factors. For example, converting creative campaign elements and offers into customized and relevant display advertisements by delivering advertisements according to the Web surfer's age, gender, location and online activities. If a user is browsing for hybrid cars in Yahoo! Autos and has selected San Francisco as default location, Yahoo's smart advertisement platform can assemble and deliver an advertisement in real time that showcases a hybrid vehicle from a major auto brand, as well as local dealer information and current lease rate, thereby providing a relevant experience to the user and allowing the marketer to reach a user who is likely to become a customer.

Blending of advertisements into the web page can be performed for different type of web pages, for example content based web pages and search pages. In search pages, the user enters a search string. The advertisements are identified based on the search string and are blended into a web page including the search results. The web page including the search results and the advertisement is then displayed.

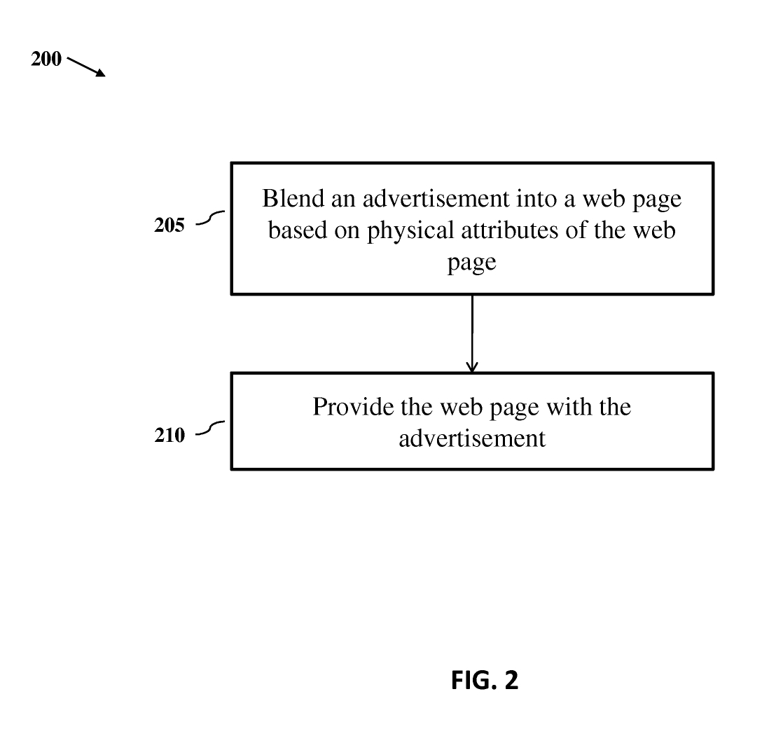

FIG. 2 illustrates a method for providing advertisements by a server, for example the server 110, in accordance with one embodiment.

At step 205, an advertisement is blended into a web page based on physical attributes of the web page. The physical attributes can either be determined by the server or can be received as an input from an electronic device via a network. The URL of the web page is also received by the server.

The advertisement is then blended into the web page. Blending includes at least one of modifying the advertisements and positioning the advertisements onto the web page. The modifying and the positioning are based on the physical attributes. The physical attributes include various parameters, associated with the web page, which can be used to help blending of the advertisement into the web page. Position or place where the advertisement is to be placed is also determined using the physical attributes. The position is determined based on the location of frames in the web page. Modifying an advertisement includes at least one of changing color of the advertisement, changing size of the advertisement, changing texture of the advertisement and changing contrast of the advertisement.

At step 210 the web page is provided with the advertisement blended in the web page. Providing the web page with the advertisement includes transmitting information of the web page and the advertisement. In one example, the transmission happens through network and the information is received by the electronic device. The web page along with the advertisement is then displayed on the electronic device.

In some embodiments, performance of the advertisement is tracked. The performance can be tracked by determining number of clicks made on the advertisement. A learning model can be developed based on the tracking. The learning model helps in improving blending of the advertisement. For example, if the advertisement when placed in X position and with Y size results in high number of clicks then the advertisement can be determined to be blended based on X position with Y size. The learning can also be applied to other advertisements.

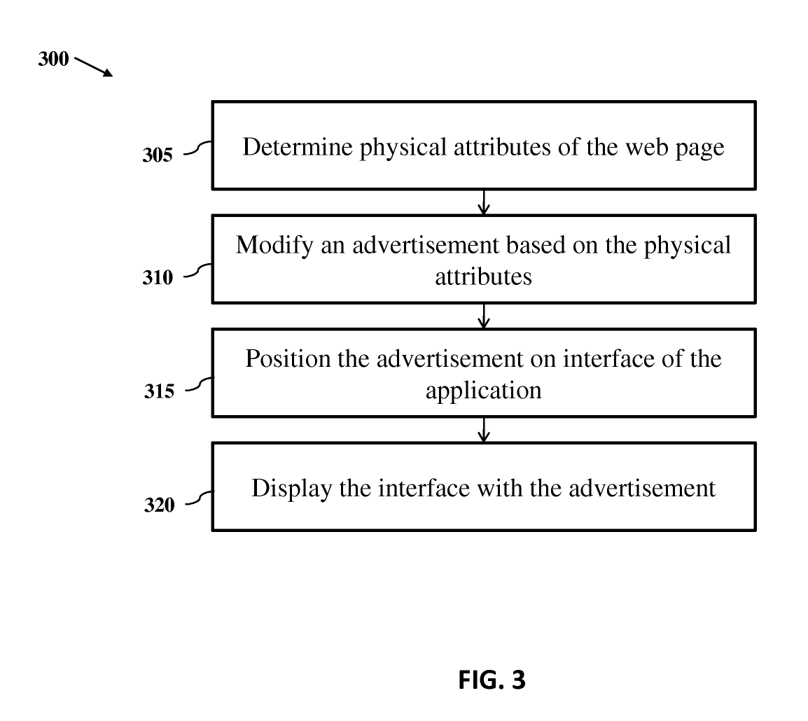

FIG. 3 illustrates a method for providing advertisements by a server, for example the server 110, in accordance with another embodiment.

At step 305, the URL of the web page along with the physical attributes of the web page is determined by the server. The physical attributes can either be determined by the server or can be received as an input from an electronic device via the network.

In an embodiment of the invention, physical attributes include color of the web page, size of the web page, texture of the web page, contrast of the web page, theme of the web page and layout of the web page.

At step 310, the advertisement is determined using various techniques, for example using various algorithms to determine what all advertisements are relevant based on content of the web page or intent of the user. The advertisement is then modified based on physical attributes of the web page.

In an embodiment of the invention, modification of the advertisement include at least one of changing color of the advertisement, changing size of the advertisement, changing texture of the advertisement and changing contrast of the advertisement.

At step 315, the position or place where the advertisement is to be placed is determined based on physical attributes of the web page. The position is determined based on the location of frames in the web page. The server determines a free space to display the advertisement in the web page. In an embodiment of the invention, the server determines the best suitable position to display the advertisement in the web page.

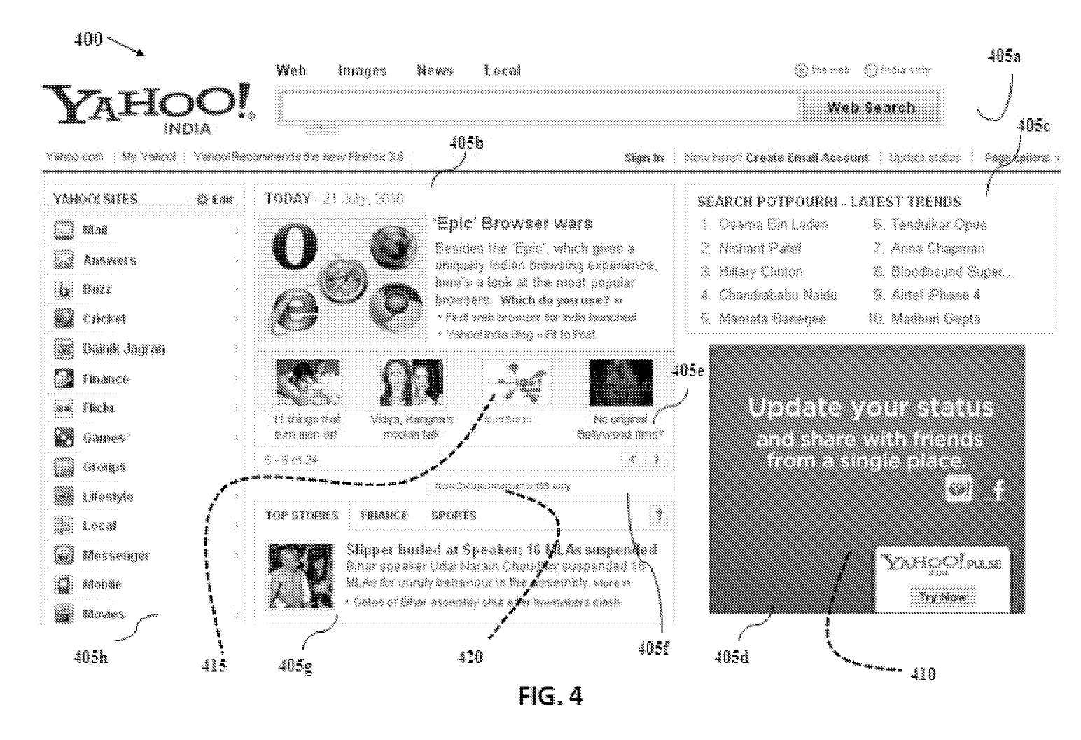

At step 320, the web page is provided with the advertisement blended in the web page to an interface of the electronic device. Providing the webpage with the advertisement includes transmitting information of the web page and the advertisement. In an embodiment of the invention, the transmission happens through network and the information is received by the electronic device. The web page along with the advertisement is then displayed on the electronic device. An example of the steps in FIG. 3 are shown in FIG. 4

FIG. 4 illustrates a web page 400 with one or more advertisements.

The web page is divided into various frames 405a, 405b, 405c, 405d, 405e, 405f, 405g and 405h.

First advertisement 410 is displayed in accordance with existing art. The first advertisement 410 is visible as an additional content on the web page. Second advertisement 415 is in accordance with the disclosure. The second advertisement 415 is blended into the web page. The second advertisement 415 is visible as content of the web page and hence, has high probability of being clicked as compared to the first advertisement 410. Similarly, third advertisement 420 is blended into the web page. The third advertisement is modified to fit into a frame 405f. The frame 405f is determined by using location of frame 405e and frame 405g. End of frame 405e and start of frame 405g are determined from the code of the web page. Size of the third advertisement 420 is modified to fit into the frame 405f. The third advertisement 420 is then positioned at the frame 405f.

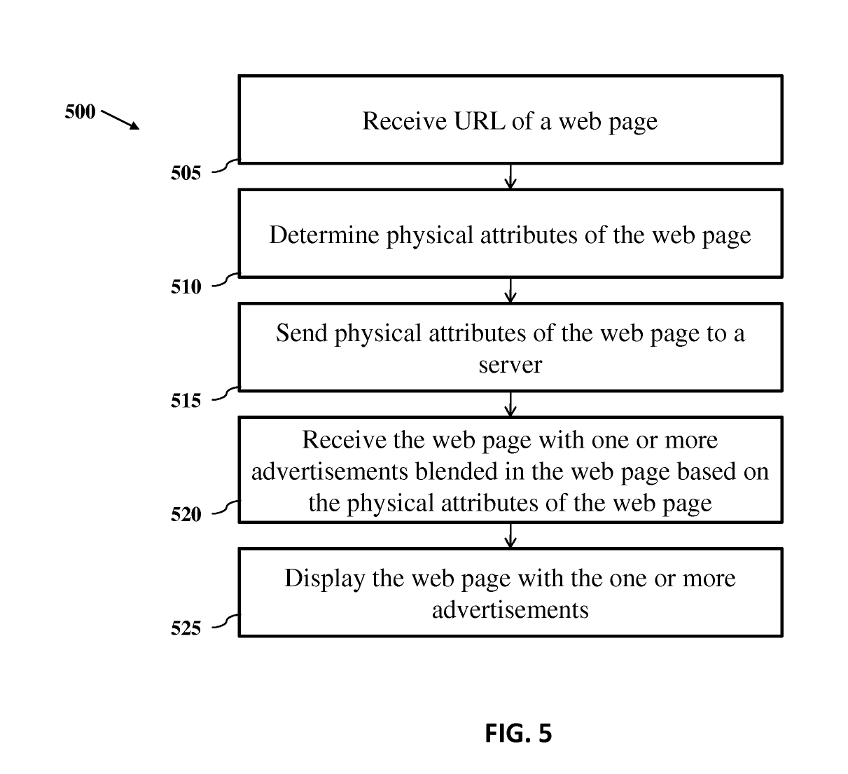

FIG. 5 illustrates a method for providing advertisements by an electronic device, for example the electronic device 115A, in accordance with one embodiment.

At step 505, the URL of the webpage is received. The URL can be typed by a user in a browser open on the electronic device. At step 510, the physical attributes of the web page are determined. The physical attributes can either be determined by the server or can be sent as an output from an electronic device via a network. The URL along with the physical attributes of the web page is electronically sent to the server in step 515.

At step 520, the electronic device receives the web page with one or more modified advertisement blended in the web page by the server via the network. Modifying an advertisement includes at least one of changing color of the advertisement, changing size of the advertisement, changing texture of the advertisement and changing contrast of the advertisement. At step 525, the web page is provided with the blended advertisement. The electronic device displays the web page with the advertisement.

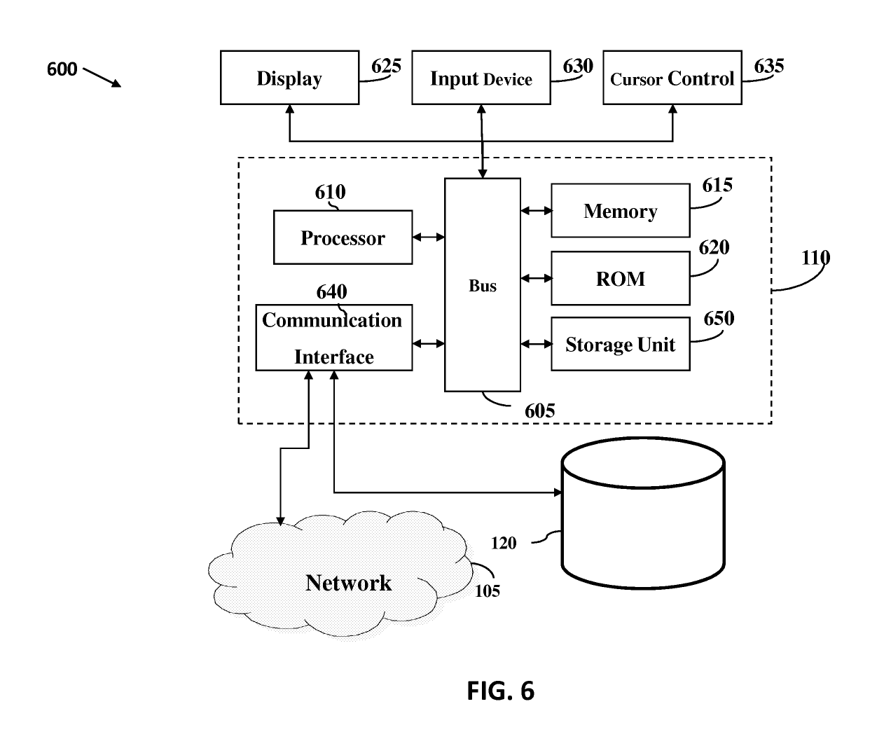

FIG. 6 illustrates a block diagram of the server 110, in accordance with one embodiment. The server 110 includes a bus 605 for communicating information, and a processor 610 coupled with the bus 605 for processing information. The server 110 also includes a memory 615, for example a random access memory (RAM) coupled to the bus 605 for storing instructions to be executed by the processor 610. The memory 615 can be used for storing temporary information required by the processor 610. The server 110 further includes a read only memory (ROM) 620 or other static storage unit coupled to the bus 605 for storing static information and instructions for processor 610. A storage unit 650, such as a magnetic disk or hard disk, can be provided and coupled to the bus 605 for storing information.

The server 110 can be coupled via the bus 605 to a display 625, for example a cathode ray tube (CRT) or liquid crystal display (LCD), for displaying information. An input device 630, including various keys, is coupled to the bus 605 for communicating information and command selections to the processor 610. In some embodiments, cursor control 635, for example a mouse, a trackball, a joystick, or cursor direction keys, for command selections to the processor 610 and for controlling cursor movement on the display 625 can also be present. The functioning of the input device 630 can also be performed using the display 625, for example a touch screen.

Various embodiments are related to the use of the server 110 for implementing the techniques described herein, for example in FIG. 2 and FIG. 3. The techniques can be performed by the server 110 in response to the processor 610 executing instructions included in the memory 615. The instructions can be read into the memory 615 from another machine-readable medium, such as the storage unit 650. Execution of the instructions included in the memory 615 causes the processor 610 to perform the techniques described herein.

The term machine-readable medium can be defined as a medium providing data to a machine to enable the machine to perform a specific function. The machine-readable medium can be a storage media. Storage media can include non-volatile media and volatile media. The memory 615 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

In some embodiments, the machine-readable medium can be transmission media including coaxial cables, copper wire and fiber optics, including the wires that include the bus 605. Transmission media can also take the form of acoustic or light waves, such as those generated during radio-wave and infra-red data communications. Examples of machine-readable medium may include but are not limited to carrier waves as describer hereinafter or any other media from which the server 110 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 110 can receive the data on the telephone line and use an infra-red transmitter to convert the data to an infra-red signal. An infra-red detector can receive the data carried in the infra-red signal and appropriate circuitry can place the data on the bus 605. The bus 605 carries the data to the memory 615, from which the processor 610 retrieves and executes the instructions. The instructions received by the memory 615 can optionally be stored on the storage unit 650 either before or after execution by the processor 610. All such media must be tangible to enable the instructions carried by the media to be detected by a physical mechanism that reads the instructions into a machine.

The server 110 also includes a communication interface 640 coupled to the bus 605 for enabling data communication. Examples of the communication interface 640 include, but are not limited to, an integrated services digital network (ISDN) card, a modem, a local area network (LAN) card, an infrared port, a Bluetooth port, a zigbee port, and a wireless port.

The server 110 can be coupled to a storage device 120 that stores the advertisements.

In some embodiments, the processor 610 can include one or more processing units for performing one or more functions of the processor 610. The processing units are hardware circuitry performing specified functions.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method comprising:
electronically blending an advertisement into a web page based on physical attributes of the web page; and
providing the web page with the advertisement.

2. The method as claimed in claim 1, wherein blending the advertisement into the web page comprises:
modifying the advertisement based on the physical attributes of the web page.

3. The method as claimed in claim 1, wherein modifying the advertisement comprises at least one of:
changing color of the advertisement;
changing size of the advertisement;
changing texture of the advertisement; and
changing contrast of the advertisement.

4. The method as claimed in claim 1, wherein blending the advertisement into the web page comprises:
positioning the advertisement on the web page based on location of frames in the web page.

5. The method as claimed in claim 1, wherein the physical attributes comprise at least one of:
color of the web page;
size of the web page;
texture of the web page;
contrast of the web page;
theme of the web page; and
layout of the web page.

6. The method as claimed in claim 1 and further comprising at least one of:
receiving the physical attributes of the web page; and
electronically determining the physical attributes of the web page.

7. The method as claimed in claim 1, wherein providing the web page comprises:
enabling display of the web page with the advertisement.

8. The method as claimed in claim 1 and further comprising:
tracking performance of the advertisement; and
blending the advertisement based on the tracking.

9. A server comprising:
a communication interface;
a memory to store instructions; and
a processor coupled to the memory and the communication interface, and responsive to the instructions to
blend an advertisement into a web page based on physical attributes of the web page; and
provide the web page with the advertisement.

10. The server as claimed in claim 9, wherein the server is electronically coupled to a storage device, the storage device comprising the advertisement.

11. An article of manufacture comprising:
a machine-readable medium; and
instructions carried by the machine-readable medium and operable to cause a programmable processor to perform
blending an advertisement into a web page based on physical attributes of the web page, and
providing the web page with the advertisement.

12. The article of manufacture as claimed in claim 11, wherein blending the advertisement into the web page comprises:
modifying the advertisement based on the physical attributes of the web page.

13. The article of manufacture as claimed in claim 12, wherein modifying the advertisement comprises at least one of:
changing color of the advertisement;
changing size of the advertisement;
changing texture of the advertisement; and
changing contrast of the advertisement.

14. The article of manufacture as claimed in claim 11, wherein blending the advertisement into the web page comprises:
positioning the advertisement on the web page based on location of frames in the web page.

15. The article of manufacture as claimed in claim 11, wherein the physical attributes comprise at least one of:
color of the web page;
size of the web page;
texture of the web page;
contrast of the web page;
theme of the web page; and
layout of the web page.

16. The article of manufacture as claimed in claim 11 and further comprising instructions operable to cause programmable processor to perform at least one of:
receiving the physical attributes of the web page; and
electronically determining the physical attributes of the web page.

17. A method comprising:
determining physical attributes associated with an interface of an application;
electronically modifying an advertisement based on the physical attributes associated with the interface of the application;
electronically positioning the advertisement on the interface of the application; and
enabling display of the interface with the advertisement.

18. The method as claimed in claim 17, wherein modifying the advertisement comprises at least one of:
changing color of the advertisement;
changing size of the advertisement;
changing texture of the advertisement; and
changing contrast of the advertisement.
